(19) United States
(12) Patent Application Publication
(10) Pub. No.: US 2004/0161222 A1
(43) Pub. Date: Aug. 19, 2004

(54) Optical waveguide, area light source device and liquid crystal display device

(76) Inventors: Eiki Niida, Kariya-shi (JP); Fumikazu Isogai, Kariya-shi (JP); Toshihiko Tsuzuki, Kariya-shi (JP); Minoru Toeda, Kariya-shi (JP); Noriyuki Besshi, Kariya-shi (JP); Yasuya Mita, Kariya-shi (JP)

Correspondence Address: MORGAN & FINNEGAN, L.L.P., 345 Park Avenue, New York, NY, 10154, US

(21) Appl. No.: 10/782,665

(22) Filed: Feb. 17, 2004

(30) Foreign Application Priority Data
Feb. 18, 2003 (JP) 2003-040054
Aug. 8, 2003 (JP) 2003-206700

(51) Int. Cl. G02B 6/00

(52) U.S. Cl. 385/146

(57) ABSTRACT

An optical waveguide includes light admitting portions and a light emitting portion. Each light admitting portion admits light from a point light source. The light emitting portion emits light admitted by the light admitting portions. Each light admitting portion has an incidence portion. Each incidence portion includes incidence planes each extending in the width direction of the light admitting portions, and V-shaped grooves, which are alternately arranged. Each light admitting portion has a pair of flat reflection planes, which extend between the corresponding incidence portion and the light emitting portion. The distance between the reflection planes in each light admitting portion increases from a side opposite from the light emitting portion toward the light emitting portion. Therefore, the light emitting efficiency of the optical waveguide is improved, and brightness unevenness created the vicinity of each point light source is reduced.

### BACKGROUND OF THE INVENTION

The present invention relates to an optical waveguide, and more particularly, to an optical waveguide that receives light from at least one point light source such as a light emitting diode (LED) and emits the received light through an area.

There exists a liquid crystal display device that includes a liquid crystal panel and an area light source device functioning as a backlight. The area light source is provided at the back surface of the liquid crystal panel, which is opposite from the display surface of the liquid crystal panel. A typical area light source device includes an optical waveguide and a fluorescent tube (a cold cathode tube). An optical waveguide is made of a highly translucent material. A fluorescent tube is provided along an end face of the optical waveguide.

As the thickness of a liquid crystal display device is reduced, the diameter of the fluorescent tube must be reduced, accordingly. However, as the diameter of a fluorescent tube is reduced, the tube is more easily broken with a small impact. Further, to cause a fluorescent tube to emit a sufficient amount of light so that the tube functions as a light source, a relatively high voltage must be applied to the tube, which requires a complicated lighting circuit.

Accordingly, an area light source device of an edge light type (side light type) having an LED instead of a fluorescent tube has been proposed. In such a device, an LED is provided to face an end face of an optical waveguide. Light from the LED is emitted from an exit plane of the waveguide that faces a liquid crystal panel. That is, light exits the waveguide through an area. However, since LEDs have strong directivity, light from a single LED hardly enters a wide optical waveguide evenly. For this reason, a technique has been proposed in which light from one or a relatively small number of LEDs is introduced in an optical waveguide and then evenly emitted through an area (for example, Japanese Laid-Open Patent Publication No. 10-293202).

As shown in FIG. 6, in the technique disclosed in Japanese Laid-Open Patent Publication No. 10-293202, a plurality of point light sources 31 face an optical waveguide 30. An end face 30a of the waveguide 30 faces the light sources 31. Continuous grooves 32 are formed on an end face 30a. In FIG. 6, the grooves 32 are exaggerated for purposes of illustration. Light from each light source 31 is divided by faces defining the grooves 32 and is diffused in a plane parallel to an exit plane 30b of the waveguide 30. This prevents formation of dark zones in areas on the waveguide 30 that correspond to spaces between the light sources 31, and formation of bright zones in areas on the waveguide 30 that correspond to the light sources 31. Accordingly, brightness unevenness of light emitted from the waveguide 30 is reduced.

However, in the configuration disclosed in Japanese Laid-Open Patent Publication No. 10-293202, after light from each light source 31 divided by faces defining the grooves 32, a greater amount of light advances in a direction that is not perpendicular to an end face 33 of the waveguide 30, which is opposite from the light sources 31. Particularly, portions of light that advance in directions substantially parallel to the end face 33 cannot be easily emitted from the waveguide 30. This locally creates brightness unevenness in the vicinity of the light sources 31.

A portion of light reaches one of end faces 34, which are perpendicular to the end face 33, while advancing through the waveguide 30. Such portion of light exits the waveguide 30 through the end face 34, not through the exit plane 30b, and does not enter the liquid crystal panel. Thus, the efficiency of use of light from the light sources 31 is low.

Further, light that advances through the waveguide 30 is repeatedly reflected by the end faces 33, 34. This extends the traveling distance of light in the waveguide 30, which greatly attenuates the light. This further degrades the efficiency of use of light from the point light sources 31.

### SUMMARY OF THE INVENTION

Accordingly, it is an objective of the present invention to improve light emitting efficiency of an optical waveguide that is used with point light sources, and to reduce brightness unevenness in the vicinity of the light sources.

To achieve the above objective, the present invention provides an optical waveguide. The waveguide admits light from a point light source, converts the admitted light into an area light, and emits the area light. The waveguide includes a light admitting portion for admitting light from the point light source. A light emitting portion is continuously formed with the light admitting portion. The light emitting portion includes an exit plane through which admitted light is emitted. A reflecting portion is formed at a side opposite from the exit plane. The light admitting portion includes an incidence portion. The incidence portion is located at a side opposite from the light emitting portion and faces the point light source. The light admitting portion has a width that increases from the incidence portion toward the light emitting portion. The incidence portion includes a plurality of incidence planes parallel to a width direction of the light admitting portion, and a plurality of diffusing portions for diffusing light from the point light source. The incidence planes and the diffusing portions are alternately arranged along the width direction of the light admitting portion. The light admitting portion includes a reflecting portion for reflecting light diffused by the diffusing portions so that the reflected light advances toward the light emitting portion.

According to another aspect of the invention, an area light source device that includes a point light source and the above-mentioned optical waveguide is provided.

In addition, present invention may be applicable to provide a liquid crystal display device that includes a liquid crystal panel and the above-mentioned area light source device. The area light source device is provided at a back surface of the liquid crystal panel, which is opposite from a display surface of the liquid crystal panel.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a schematic plan view illustrating an optical waveguide according to one embodiment of the present invention;

FIG. 1(b) is a partially enlarged view illustrating a light admitting portion of the optical waveguide of FIG. 1(a);

FIG. 2 is a schematic view illustrating a liquid crystal display device having the optical waveguide of FIG. 1(a);

FIG. 3 is a partially enlarged view illustrating an operation of the optical waveguide of FIG. 1(a);

FIG. 4 is a schematic plan view illustrating an operation of the optical waveguide of FIG. 1(a);

FIG. 5 is a partially enlarged view illustrating an optical waveguide according to another embodiment; and

FIG. 6 is a schematic view illustrating a prior art optical waveguide.

### DETAILED DESCRIPTION OF THE PREFERRED EMBODIMENTS

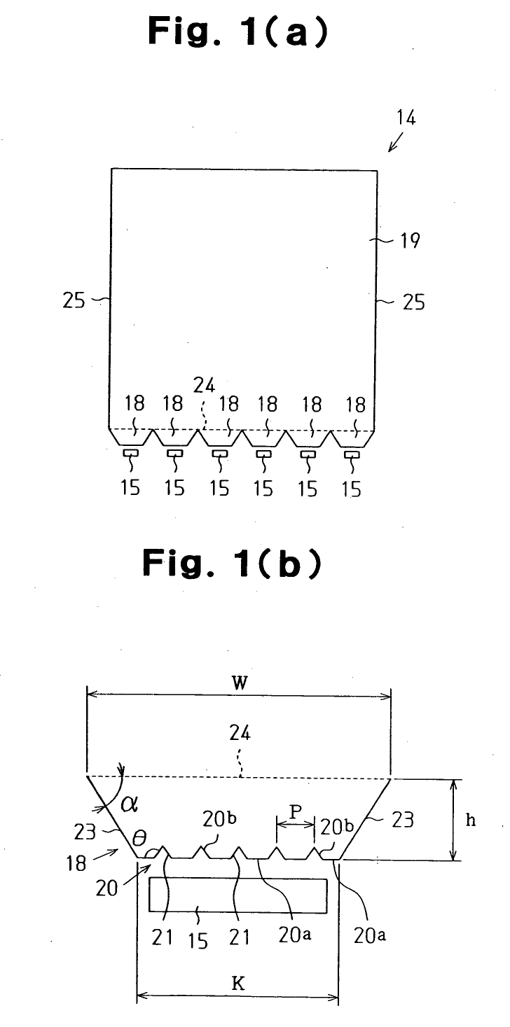

One embodiment according to the present invention will now be described with reference to FIGS. 1(a) to 4.

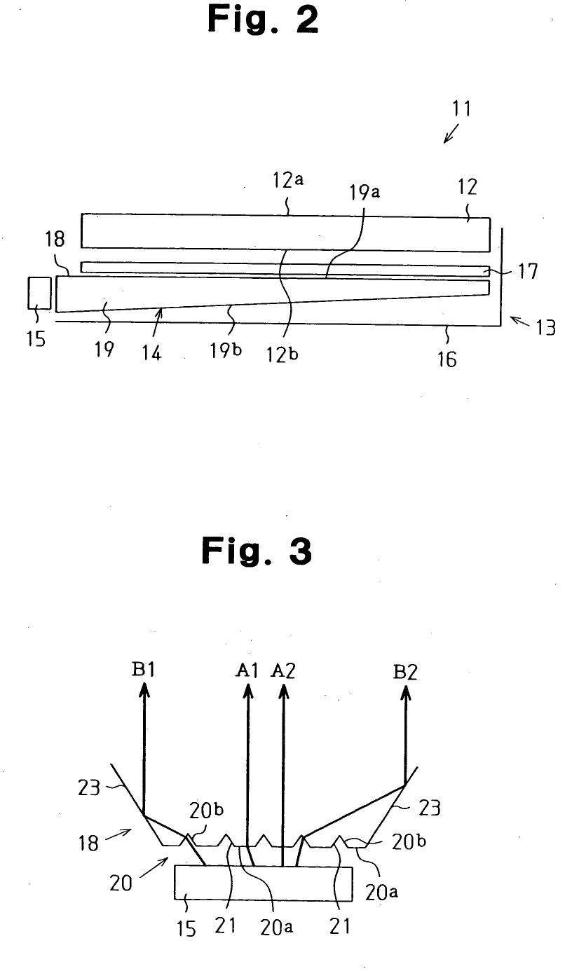

As shown in FIG. 2, a transmissive liquid crystal display device 11 includes a liquid crystal panel 12 and an area light source device 13. The liquid crystal panel 12 includes a display surface 12a and a back surface 12b, which is opposite from the display surface 12a. The area light source device 13 functions as a backlight unit of a sidelight type and is provided facing the back surface 12b of the liquid crystal panel 12. As shown in FIGS. 1(a) and 2, the area light source device 13 includes an optical waveguide 14 and point light sources 15. The number of the light sources 15 is six in this embodiment. The point light sources 15 are arranged along and face an end face of the optical waveguide 14 that extends along a width direction of the waveguide 14 (lateral direction as viewed in FIG. 1(a)). Light emitting diodes (LED) are used for the point light sources 15.

As shown in FIG. 2, a reflection sheet 16, which functions as a reflecting member, is provided about the area light source device 13. The reflection sheet 16 is located at an opposite side of the optical waveguide 14 from the liquid crystal panel 12. Light that escapes from the waveguide 14 is reflected by the reflection sheet 16 and returned to the waveguide 14. Light is then emitted through the display surface 12a. An optical sheet 17 is provided between the optical waveguide 14 and the liquid crystal panel 12. The optical sheet 17 is typically a light diffusion sheet, a lens sheet, a prism sheet, or a reflective polarizing sheet. Alternatively, the optical sheet 17 may be formed by combining at least two of these sheets. Although a combination of two or more sheets is typically used for the optical sheet 17, the sheet 17 is schematically illustrated as a single sheet in FIG. 2.

The optical waveguide 14 will now be described. As shown in FIGS. 1(a) and 2, the optical waveguide 14 has light admitting portions 18 and a light emitting portion 19. The number of the light admitting portions 18 is equal to the number of the point light sources 15. Each light admitting portion 18 faces different one of the point light sources 15. Each light admitting portion 18 diffuses light from the corresponding light source 15 and guides light to the light emitting portion 19. The light emitting portion 19 is formed as a plate and includes an light exit plane 19a, through which light from the light admitting portions 18 is emitted, and a reflecting plane 19b, which is opposite from the exit plane 19a and functions as a reflecting portion. The reflecting plane 19b reflects light that has been admitted in the light emitting portion 19 toward the light exit plane 19a. Although not illustrated, the reflecting plane 19b has a plurality of V-shaped grooves or sawtooth grooves.

The light emitting portion 19 is formed continuously with the light admitting portions 18. The light admitting portions 18 are formed at an end face of the optical waveguide 14 that faces the point light sources 15 and arranged along the width direction of the waveguide 14 (width direction of the light emitting portion 19). The light admitting portions 18 are successively formed. The width W of each admitting portion 18 (see FIG. 1(b)) is determined by dividing the width of the waveguide 14 (width of the light emitting portion 19) by the number of the point light sources 15. A high transparency material, for example, an acrylic resin is used for the optical waveguide 14.

As shown in FIG. 1(b), the width of each admitting portion 18 increases from the side corresponding to the point light sources 15, or the side opposite from the light emitting portion 19, toward the light emitting portion 19. Each admitting portion 18 is symmetrical with respect to a line that extends from the side facing the corresponding light source 15 toward the light emitting portion 19. An end of each admitting portion 18 which is opposite from the light emitting portion 19, or an end that faces the corresponding light source 15, forms an incidence portion 20. The width K of the incidence portion 20 (lateral measurement as viewed in FIG. 1(b)) is slightly greater than the width of the light sources 15. Each incidence portion 20 includes incidence planes 20a and V-shaped grooves 20b. The incidence planes 20a and the V-shaped grooves 20b are arranged alternately. The incidence planes 20a are spaced at an equal interval. The incidence planes 20a extend along the width direction of the admitting portion 18. The incidence planes 20a are parallel to an imaginary plane 24 that extends along the width direction of the admitting portion 18 at the boundary between the admitting portions 18 and the light emitting portion 19. Each V-shaped groove 20b is defined by inclined faces 21. The inclined faces 21 function as diffusing portions for diffusing light from the corresponding light source 15. In this embodiment, the proportion D of the incidence planes 20a in each incidence portion 20, or the proportion of the sum of the width of all the incidence planes 20a in the width K of the incidence portion 20, is in a range between 35% and 55% inclusive.

Each V-shaped groove 20b narrows toward the light emitting portion 19. The cross-section of each V-shaped groove 20b along a plane parallel to the light exit plane 19a is an isosceles triangle. The base of each isosceles triangle is in a plane that contains the incidence planes 20a of the incidence portions 20. Accordingly, the center of each V-shaped groove 20b with respect to the width direction of the waveguide 14 coincides with the apex of the isosceles triangle (the bottom of the V-shaped groove 20b). The angle θ defined by each of the inclined faces 21 and the corresponding incidence plane 20a in the incidence portion 20 is in a range between 130 degrees and 145 degrees inclusive. In this embodiment, all the V-shaped grooves 20b have the same shape. Also, all the V-shaped grooves 20b in each incidence portion 20 are arranged at equal intervals. The interval between the bottoms of each adjacent pair of the V-shaped grooves 20b is referred to as a pitch P of the bottoms of the V-shaped grooves 20b. The pitch P (that is, the distance between the centers of adjacent diffusing portions) is 0.2 mm. The ratio R of the interval between each adjacent pair of the incidence planes 20a to the pitch P is in a range between 0.45 and 0.65 inclusive.

The sides of each admitting portion 18 function as reflection planes 23. Each reflection plane 23 functions as a reflecting portion and is a plane located between the corresponding incidence portion 20 and the light emitting portion 19. The distance between the reflection planes 23 in each admitting portion 18 increases from the side facing the corresponding light source 15 toward the light emitting portion 19. The angle α defined by each reflection plane 23 and the imaginary plane 24 extending along the width direction of the admitting portion 18 is in a range between 40 degrees and 50 degrees inclusive.

The operation of the optical waveguide 14 will now be described.

When the point light sources 15 emit light, light from the light sources 15 enters the waveguide 14. Light is then emitted from the light exit plane 19a of the waveguide 14 and heads for the liquid crystal panel 12. Light passes through the optical sheet 17 and enters the liquid crystal panel 12. Light makes contents on the liquid crystal panel 12 visible to a user of the liquid crystal display device 11.

As shown in FIG. 3, the operation of the optical waveguide 14 will now be discussed in more detail. Most of light from each point light source 15 reaches the corresponding incidence portion 20. Some of light that has reached the incidence portion 20 enters the admitting portion 18 from the corresponding incidence planes 20a. As indicated by arrows A1, A2, most of light that has entered the admitting portion 18 through the incidence planes 20a advances in a direction substantially perpendicular to the incidence planes 20a. Thus, most of light that reaches the admitting portion 18 from the incidence planes 20a advances through the admitting portion 18 and the light emitting portion 19 along directions that are nearly perpendicular to the imaginary plane 24 extending in the width direction of the admitting portions 18.

That is, most of light that reaches the admitting portions 18 from the incidence planes 20a, which extend along the width direction of the admitting portions 18, advances in a direction substantially perpendicular to the width direction of the optical waveguide 14. Therefore, little amount of light escapes the optical waveguide 14 from end faces 25 (see FIG. 1(a)) of the waveguide 14, which are perpendicular to the width direction of the waveguide 14. Also, little amount of light is reflected by the end faces 25. Thus, light that enters each admitting portion 18 through the corresponding incidence planes 20a travels through the interior of the waveguide 14 substantially in the shortest distance between the entering point, to which the light enters the waveguide 14, and the exiting point, from which the light exits the waveguide 14 through the exit plane 19a.

As shown in FIG. 3, a portion of light that reaches each incidence portion 20 does not enter the admitting portion 18 through the incidence planes 20a. This portion of light enters the admitting portion 18 through one of the inclined faces 21 defining the V-shaped grooves 20b. Light that enters the admitting portion 18 through the inclined face 21 is refracted, or diffused, by the inclined face 21 and caused to advance toward the reflection plane 23. As indicated by arrows B1, B2, most of light diffused by the inclined faces 21 is reflected by the reflection planes 23, and advances in a direction substantially perpendicular to the width direction of the waveguide 14.

Therefore, like the case of light that enters each admitting portion 18 from the incidence planes 20a, most of light that enters the admitting portion 18 after being refracted by the inclined faces 21 of the V-shaped grooves 20b travels through the interior of the waveguide 14 substantially in the shortest distance between the entering point, to which the light enters the waveguide 14, and the exiting point, from which the light exits the waveguide 14 through the exit plane 19a.

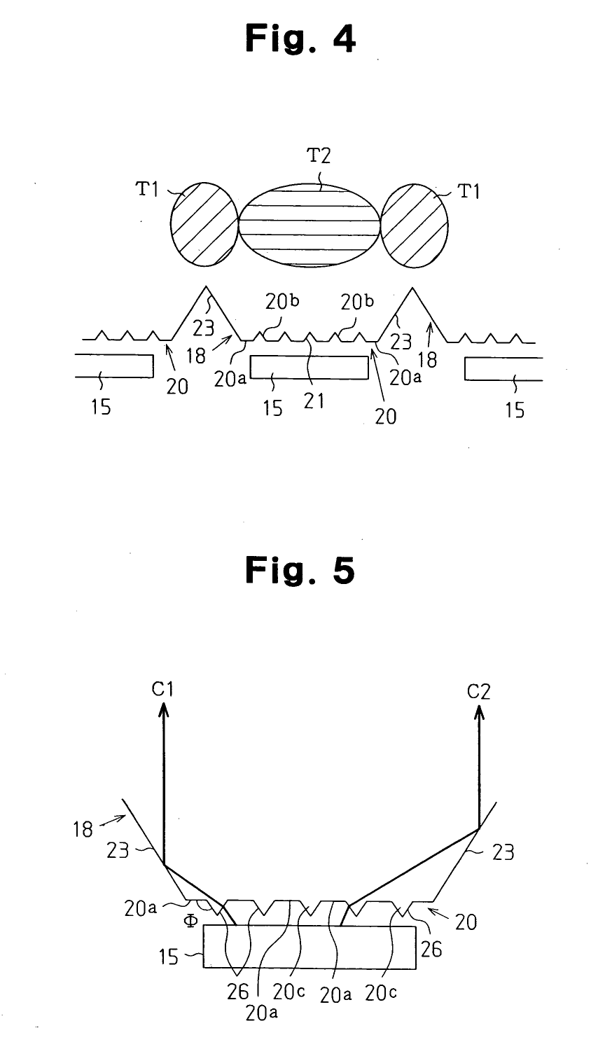

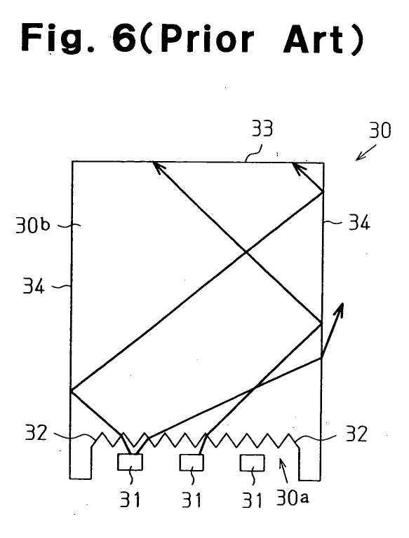

As shown in FIG. 4, light reflected by the reflection planes 23 advances through the first areas T1 of the waveguide 14 corresponding to gaps between adjacent point light sources 15. The first areas T1 are diagonally shaded.

The inventors of the present invention performed analyses and experiments to discover preferable ranges of the angle α, the angle θ, the proportion D, and the ratio R. The results of the analyses and experiments will be discussed below. The measurements of a basic shape in the admitting portions 18 used in the analyses are shown in chart 1.

CHART 1

| Parameter | Value |
|---|---|
| Angle α defined by each reflection plane 23 | 45 |
| and the imaginary plane 24 [degrees] | |
| Angle θ defined by each inclined face 21 and | 135 |
| the incidence plane 20a [degrees] | |
| Proportion D of the incidence planes 20a in | 50 |
| the incidence portion 20 [%] | |
| Ratio R of the interval between adjacent | 0.5 |
| incidence planes 20a to the pitch of the | |
| bottoms of the V-shaped grooves 20b | |
| Width K of each incidence portions 20 [mm] | 4.4 |
| Pitch P of the bottoms of the V-shaped grooves | 0.2 |
| 20b [mm] | |
| Maximum width W of each admitting portion 18 | 9 |
| [mm] | |
| Distance h between the incidence portions 20 | 3 |
| and the light emitting portion 19 [mm] | |

Chart 2 shows the relationship between a brightness ratio and the angle α defined by each reflection plane 23 and the imaginary plane 24. The brightness ratio refers to the ratio of the maximum brightness to the minimum brightness of light emitted by the optical waveguide 14 in the vicinity of each point light source 15. Through experiments, it has been confirmed that there is no problems in practical use as long as the brightness ratio is equal to or less than 1.05 even if the diffusing property of the light diffusion sheet in the optical sheet 17 between the waveguide 14 and the liquid crystal panel 12 is relatively small (for example, if the Haze is about 85 to 90%). Also, through experiments, it has been confirmed that there is no problems in practical use even if the brightness ratio is equal to or less than 1.2 as long as the diffusion property of the light diffusion sheet is increased (for example, if the Haze is about 90 to 95%), and the dispersion of light in the liquid crystal panel 12 is adequately adjusted.

As the angle α is increased, the proportion of light that is not reflected by but passes through the reflection planes 23 increases in light diffused by the inclined faces 21 of the V-shaped grooves 20b. Accordingly, the proportion of light that is emitted from the exit plane 19a is decreased. Therefore, the brightness of the first areas T1 of the waveguide 14, each of which corresponds to a gap between an adjacent pair of the point light sources 15, is reduced. To the contrary, as the angle α is decreased, light reflected by each reflection plane 23 is more apt to advance in directions other than the direction perpendicular to the width direction of the waveguide 14. Therefore, as in the case where the angle α is too large, the brightness of the first areas T1 is reduced when the angle α is too small. Thus, the ratio of the brightness of the first areas T1 to the brightness of second areas T2 (see FIG. 4) of the waveguide 14, each of which corresponds to one of the point light sources 15, needs to be adjusted by adjusting the angle α.

The chart 2 below shows that, if the angle α has a value in a range between 35 degrees and 65 degrees inclusive, the brightness ratio is equal to or less than 1.2, and that, if the angle α has a value in a range between 40 degrees and 50 degrees inclusive, the brightness ratio is equal to or less than 1.05.

CHART 2

| α [degree] | Brightness Ratio |
|---|---|
| 30 | 1.3 |
| 35 | 1.1 |
| 40 | 1.05 |
| 45 | 1.03 |
| 50 | 1.02 |
| 52.5 | 1.1 |
| 55 | 1.15 |
| 60 | 1.17 |
| 65 | 1.19 |

Chart 3 shows the relationship between the brightness ratio and the angle θ defined by each of the inclined faces 21 and each of the incidence planes 20a.

A portion of light that is refracted by the inclined faces 21 of each V-shaped groove 20b does not reach any of the corresponding reflection planes 23, but reaches one of the adjacent V-shaped grooves 20b. As a result, such portion of light is not emitted from the exit plane 19a of the waveguide 14. As the angle θ is decreased, the proportion of such portion of light in light refracted by the inclined faces 21 is increased. In this case, the brightness of the first areas T1 is reduced. Another portion of light that is refracted by the inclined faces 21 directly reaches the light emitting portion 19 without being reflected by any of the corresponding reflection planes 23. As the angle θ is increased, the proportion of such portion of light in light refracted by the inclined faces 21 is increased. In this case, the brightness of the first areas T1 is reduced.

The following chart 3 shows that, if the angle θ has a value in a range between 120 degrees and 155 degrees inclusive, the brightness ratio is equal to or less than 1.2, and that, if the angle θ has a value in a range between 130 degrees and 145 degrees inclusive, the brightness ratio is equal to or less than 1.05.

CHART 3

| θ [degrees] | Brightness Ratio |
|---|---|
| 115 | 1.26 |
| 120 | 1.17 |
| 125 | 1.1 |
| 127.5 | 1.07 |
| 130 | 1.04 |
| 135 | 1.03 |
| 140 | 1.02 |
| 145 | 1.05 |
| 150 | 1.1 |
| 155 | 1.18 |
| 160 | 1.21 |

Chart 4 shows the relationship between the brightness ratio and the proportion D of the incidence planes 20a in the incidence portion 20. A portion of light from each point light source 15 advances to the corresponding second area T2 of the waveguide 14. As the proportion D is increased, the proportion of such light in light from the point light source 15 is increased. To the contrary, as the proportion D is decreased, or as the proportion of the V-shaped grooves 20b is increased, more of light reaches the first areas T1. Thus, the proportion D of the incidence planes 20a needs to be adjusted to equalize the amount of light that reaches each second area T2 with the mount of light that reaches each first area T1.

The following chart 4 shows that, if the proportion D of the incidence planes 20a in each incidence portion 20 has a value in a range between 35% and 55% inclusive, the brightness ratio is equal to or less than 1.05.

CHART 4

| D(%) | Brightness Ratio |
|---|---|
| 25 | 1.06 |
| 35 | 1.03 |
| 40 | 1.02 |
| 50 | 1.03 |
| 55 | 1.04 |
| 65 | 1.1 |
| 70 | 1.15 |

Chart 5 shows the relationship between the brightness ratio and the ratio R of the interval between each adjacent pair of the incidence planes 20a to the pitch P of the bottoms of the V-shaped grooves 20b. As the ratio R is increased, the proportion of the V-shaped grooves 20b in each incidence portion 20 is increased, and the proportion D of the incidence planes 20a is reduced. To the contrary, as the ratio R is decreased, the proportion of the V-shaped grooves 20b in each incidence portion 20 is reduced, and the proportion D of the incidence planes 20a is increased. Thus, as in the case of the proportion D, the ratio R needs to be adjusted to equalize the amount of light that reaches each second area T2 with the mount of light that reaches each first area T1.

The chart 5 below shows that, if the ratio R of the interval has a value in a range between 0.25 and 0.8 inclusive, the brightness ratio is equal to or less than 1.2, and that, if the ratio R has a value in a range between 0.45 and 0.65 inclusive, the brightness ratio is equal to or less than 1.05.

CHART 5

| R | Brightness Ratio |
|---|---|
| 0.2 | 1.23 |
| 0.25 | 1.18 |
| 0.3 | 1.15 |
| 0.35 | 1.1 |
| 0.45 | 1.04 |
| 0.5 | 1.03 |
| 0.6 | 1.02 |
| 0.65 | 1.03 |
| 0.75 | 1.06 |
| 0.8 | 1.13 |
| 0.85 | 1.23 |

This embodiment provides the following advantages.

(1) Each admitting portion 18 of the optical waveguide 14 widens toward the light emitting portion 19 from a side opposite from the light emitting portion 19. Each admitting portion 18 has the incidence portion 20 at the side opposite from the light emitting portion 19. The incidence portion 20 faces the corresponding point light source 15. The incidence portion 20 includes the incidence planes 20a parallel to the width direction of the admitting portion 18, and the V-shaped grooves 20b, which are defined by the inclined faces 21. The inclined faces 21 diffuse light from the point light source 15. The incidence planes 20a and the V-shaped grooves 20b are formed alternately.

Since some of light from the point light sources 15 is diffused by the inclined faces 21 of the V-shaped grooves 20b, light advances through the entire waveguide 14. Therefore, the formation of dark zones is prevented in the first areas T1. Also, the formation of bright zones is prevented in the second areas T2. Thus, the brightness unevenness of light emitted by the optical waveguide 14 in the vicinity of each point light source 15 is reduced.

Most of light that enters the optical waveguide 14 through the incidence planes 20a is not reflected by anything and advances in a direction substantially perpendicular to the width direction of the waveguide 14 until it reaches the reflecting planes 19b. Therefore, most of light that enters the optical waveguide 14 through the incidence planes 20a does not exit the waveguide 14 through the end faces 25. Also, most of light does not advance through the waveguide 14 while being repeatedly reflected by the end faces 25. Instead, most of light advances through the interior of the waveguide 14 substantially in the shortest distance until the light exists the waveguide 14 from the exit plane 19a. This minimizes the attenuation of light in the optical waveguide 14. Further, the proportion of light that exits the waveguide 14 through exit plane 19a in light that enters the waveguide 14 from the point light sources 15 is increased. Accordingly, the light emitting efficiency of the optical waveguide 14 is improved.

(2) Each admitting portion 18 has two of the reflection planes 23 located between the incidence portion 20 and the light emitting portion 19. The distance between the reflection planes 23 in each admitting portion 18 increases from a side opposite from the light emitting portion 19 toward the light emitting portion 19. A portion of light from the corresponding point light source 15 that enters the waveguide 14 through the inclined faces 21, which define the V-shaped grooves 20b, is refracted by the inclined face 21 so that such portion advances toward the reflection planes 23.

Most of light refracted by the inclined faces 21 is reflected by the reflection planes 23 and advances in a direction substantially perpendicular to the width direction of the waveguide 14. Therefore, like light that enters the waveguide 14 through the incidence planes 20a, most of light that enters the waveguide 14 through the V-shaped grooves 20b advances in a direction substantially perpendicular to the width direction of the waveguide 14. The light thus advances through the waveguide 14 in the shortest distance until the light exits the waveguide 14 from the exit plane 19a. That is, most of light that enters the waveguide 14 through the V-shaped grooves 20b does not exit from the end faces 25 nor advance through the waveguide 14 while being repeatedly reflected by the end faces 25. Accordingly, the attenuation of light in the waveguide 14 is minimized, and the light emitting efficiency of the waveguide 14 is improved.

Each reflection plane 23 is located between one of the light sources 15 and the adjacent light source 15. Most of light reflected by the reflection plane 23 advances in a direction perpendicular to the width direction of the waveguide 14. Thus, compared to the technique disclosed in Japanese Laid-Open Patent Publication No. 10-293202, the brightness of the first areas T1 of the waveguide 14 is increased.

(3) A portion of light from each point light source 15 that enters the waveguide 14 through the corresponding incidence planes 20a and another portion of the light that enters the waveguide 14 through the corresponding V-shaped grooves 20b both advance in directions nearly perpendicular to the width direction of the waveguide 14. Therefore, light is emitted from the exit plane 19a in substantially the same direction. Thus, instead of using two prism sheets for the optical sheet 17, the optical sheet 17 may include only one prism sheet.

(4) Each admitting portion 18 is symmetrical with respect to a line that extends from the side opposite from the light emitting portion 19 toward the light emitting portion 19. Therefore, man-hours required for designing and producing the above described waveguide 14 are reduced.

(5) The diffusing portions are inclined faces 21 that define the V-shaped grooves 20b, each of which is recessed from the incidence portion 20 toward the light emitting portion 19. Therefore, light of the point light sources 15 is diffused with a simple structure. Thus, the man-hours for designing and producing the waveguide 14 are further reduced.

(6) The angle θ defined by each of the inclined faces 21, which define the V-shaped grooves 20b, and the corresponding incidence plane 20a has a value in a range between 130 degrees and 145 degrees inclusive. Therefore, the direction in which light refracted by the inclined faces 21 of the V-shaped grooves 20b is optimized. That is, the proportion of light that is refracted by the inclined faces 21 and reaches the reflection planes 23 is maximized. Accordingly, the brightness of the first areas T1 is increased, and the brightness unevenness is further reduced.

(7) The angle α defined by each reflection plane 23 and the imaginary plane 24 extending along the width direction of the admitting portion 18 is in a range between 40 degrees and 50 degrees inclusive. Therefore, the ratio of the brightness of the second areas T2 to the brightness of the first areas T1 is optimized. Accordingly, the brightness unevenness on the exit plane 19a of the waveguide 14 is further reduced.

Most of light diffused by the inclined faces 21 of the V-shaped grooves 20b is reflected in a direction perpendicular to the width direction of the admitting portions 18. This increases the efficiency of use of light. Further, in each of the first areas T1 light advances in a direction substantially perpendicular to the width direction of the admitting portion 18 more certainly. This further reduces the brightness unevenness.

(8) The proportion D of the incidence planes 20a in each incidence portion 20 has a value in a range between 35% and 55% inclusive. A portion of light that enters the waveguide 14 through each incidence portion 20 advances to one of the second areas T2. This portion of light is not diffused by the admitting portion 18. Another portion of light advances to one of the first areas T1. This portion of light is diffused by the admitting portion 18. The proportion of the amount of the portion of light toward the first area T1 to the amount of the portion of light toward the second area T2 is optimized, that is, the proportion is equalized, which further reduces the brightness unevenness.

(9) The ratio R of the interval between each adjacent pair of the incidence planes 20a in each incidence portion 20 to the pitch P of the bottoms of the V-shaped grooves 20b in each incidence portion 20 has a value in a range between 0.45 and 0.65 inclusive. Thus, an advantage similar to the advantage (8) is obtained.

(10) The admitting portions 18 are arranged adjacent to one another. Therefore, although the width of the waveguide 14 is significantly greater than the width of each point light source 15, the light emitting efficiency is not decreased, and the brightness unevenness of emitted light is reduced. That is, the present invention is readily applied to the wide waveguide 14.

The invention may be embodied in the following forms.

The grooves 20b are defined by the inclined faces 21, which function as diffusing portions. The grooves 20b are V-shaped. However, the shape of the grooves 20b is not limited to V shape as long as light from each point light source 15 is refracted toward the reflection planes 23. For example, the grooves 20b may have a semi-elliptic shape. In this case, as in the case of the V-shaped grooves 20b, the brightness unevenness of the waveguide 14 is decreased.

In this case, the center of each diffusing portion in the width direction of the light admitting portion 18 is defined as the center of the diffusing portion, and the distance between the centers of each adjacent pair of the diffusing portion is determined.

In the above illustrated embodiments, the distance from each incidence portion 20 to the bottom of each V-shaped groove 20b, or the depth of the V-shaped grooves 20b, is constant. However, the depth of the V-shaped grooves 20b need not be constant.

The diffusing portions in each admitting portion 18 need not be faces defining grooves. For example, the diffusing portions may be modified as shown in FIG. 5. In the modification of FIG. 5, projections 20c extend from the incidence portion 20 in a direction away from the light emitting portion 19. In this case, faces 26 of the projections 20c function as the diffusing portions. The projections 20c need not be shaped as triangle poles as shown in FIG. 5, but may be shaped as half-elliptic poles. When the faces 26 of each projection 20c function as diffusing portions, as indicated by arrows C1, C2 in FIG. 5, a portion of light from the point light source 15 that reaches the projections 20c is refracted by the faces 26 and heads for the reflection planes 23. Therefore, even if the faces 26 of the projections 20c function as the diffusing portions, the same advantages are obtained as the case where the inclined faces 21 defining the V-shaped grooves 20b are used for the diffusing portions.

The inventors examined the relationship between the brightness ratio and the angle Φ defined by each incidence plane 20a and an adjoining face 26 when the faces 26 of the projections 20c having a triangle pole cross-section are used for the diffusing portions. As a result, the relationship between the brightness ratio and the angle Φ is similar to the relationship shown in the chart 3 between the brightness ratio and the angle θ of the case where the inclined faces 21 defining the V-shaped grooves 20b are used for the diffusing portions. That is, if the angle Φ is in a range between 120 degrees and 165 degrees inclusive, the brightness ratio is equal to or less than 1.2. If the angle Φ is in a range between 130 degrees and 150 degrees inclusive, the brightness ratio is equal to or less than 1.05.

The inventors also examined the relationship between the brightness ratio and the proportion D of the incidence planes 20a in each incidence portion 20 when the faces 26 of the projections 20c having a triangle pole cross-section are used for the diffusing portions. The results are similar to those of the case where the inclined faces 21 defining the V-shaped grooves 20b are used for the diffusing portions. That is, if the proportion D of the incidence planes 20a in each incidence portion 20 is in a range between 20% and 75% inclusive, the brightness ratio is equal to or less than 1.2. If the proportion D is in a range between 35% and 55% inclusive, the brightness ratio is equal to or less than 1.05.

Therefore, in the case where the faces 26 of the projections 20c having triangle pole cross-section are used for the diffusing portions, light from each point light source 15 is effectively diffused with a simple structure. Thus, the man-hours for designing and producing the waveguide 14 are reduced.

The size of the admitting portions 18 is not limited to those listed in the chart 1, but may be changed as necessary according to parameters such as the size and the number of the point light sources 15, and the size of the waveguide 14. In this case, if the shape of each admitting portion 18 is similar to the admitting portion 18 of the size shown in the chart 1, optimal values of the angle α, the angle θ, the proportion D, and the ratio R are the same as those listed above.

A reflection sheet or a reflecting member made by metal deposition may be provided for each reflection planes 23. The reflection sheet or the reflecting member may contact or be spaced from the reflection plane 23. In this case, all the light that reaches each reflection plane 23 is reflected toward the light emitting portion 19. That is, no light escapes through the reflection planes 23. Therefore, the light emitting efficiency of the waveguide 14 is further improved.

In the illustrated embodiments, the reflection planes 23 functioning as the reflecting portions are flat. However, the reflecting portion need not be flat. For example, the reflecting portion may be a curved surface that bulges toward the outside of the waveguide 14. Alternatively, the reflecting portion may be formed with multiple faces. In these cases, the curvature of the curved surface or the orientations of the multiple faces are adjusted so that most of light reflected by the reflecting portions advances in directions substantially perpendicular to the width direction of the admitting portions 18.

In the illustrated embodiments, V-shaped grooves or sawtooth grooves are formed in the reflecting plane 19b of the light emitting portion 19. Instead of such grooves, dots for diffusing light may be formed. Alternatively, light emitting portion utilizing volume scattering effect may be provided. The light emitting portion 19, that is, the optical waveguide 14, is formed of a highly transparent material. The light emitting portion utilizing volume scattering effect is formed by dispersing bubbles or beads having a different refractive index from the material of the waveguide 14 so that the light emitting portion reflects or refracts light (visible radiation).

In the above illustrated embodiments, the V-shaped grooves 20b are formed at the constant pitch on the incidence portion 20. However, the V-shaped grooves 20b may be formed at uneven pitch. For example, by adjusting the interval of the V-shaped grooves 20b, the brightness unevenness can be reduced. Likewise, the brightness unevenness can be reduced when the projections 20c are provided instead of recesses such as the V-shaped grooves 20b forming the diffusing portions. In these cases, the ratio R is determined by using the average value of the distance between the centers of adjacent pairs of the diffusing portions and the average value of the intervals between adjacent pairs of the incidence planes 20a.

In the illustrated embodiments, the optical waveguide 14 is made of an acrylic resin. However, the waveguide 14 is made of any transparent resin such as polycarbonate, Zeonor (trademark), or Arton (trademark).

In the illustrated embodiments, the thickness of the waveguide 14 decreases from the side corresponding the admitting portion 18 toward the side opposite from the admitting portion 18. However, the thickness of the waveguide 14 may be, for example, constant.

The number of the admitting portions 18 is not limited to six, but may be changed as necessary according to the width of the light emitting portion 19. For example, only one admitting portion 18 may be provided when the required width of the light emitting portion 19 is narrow.

The number of the point light sources 15 is not limited six, but may be changed as necessary.

Light sources other then LEDs may be used for the point light sources 15.

In the illustrated embodiments, the light exit plane 19a is flat. However, prisms may be provided on the light exit plane 19a. Prisms increase the brightness in a certain direction.

The prism is preferably integrally formed with the waveguide 14. The prism preferably extends in a direction perpendicular to the direction along which the V-shaped or sawtooth shaped grooves formed in the reflecting plane 19b.

In the illustrated embodiments, each admitting portion 18 is symmetrical with respect to a line that extends from the side opposite from the light emitting portion 19 toward the light emitting portion 19. However, the admitting portion 18 need not by symmetrical.

The present examples and embodiments are to be considered as illustrative and not restrictive and the invention is not to be limited to the details given herein, but may be modified within the scope and equivalence of the appended claims.

1. An optical waveguide, which admits light from a point light source, converts the admitted light into an area light, and emits the area light, the waveguide comprising:
a light admitting portion for admitting light from the point light source; and
a light emitting portion continuously formed with the light admitting portion, wherein the light emitting portion includes an exit plane through which admitted light is emitted, and a reflecting portion formed at a side opposite from the exit plane,
wherein the light admitting portion includes an incidence portion, which is located at a side opposite from the light emitting portion and faces the point light source, wherein the light admitting portion has a width that increases from the incidence portion toward the light emitting portion, wherein the incidence portion includes a plurality of incidence planes parallel to a width direction of the light admitting portion, and a plurality of diffusing portions for diffusing light from the point light source, wherein the incidence planes and the diffusing portions are alternately arranged along the width direction of the light admitting portion, and wherein the light admitting portion includes a reflecting portion for reflecting light diffused by the diffusing portions so that the reflected light advances toward the light emitting portion.

2. The optical waveguide according to claim 1, wherein the light admitting portion is symmetrically widened from the incidence portion toward the light emitting portion.

3. The optical waveguide according to claim 1, wherein the diffusing portions are inclined faces that define V-shaped grooves, and wherein, in relation to the incidence planes, the V-shaped grooves are recessed toward the light emitting portion.

4. The optical waveguide according to claim 3, wherein an angle defined by each of the inclined faces and the adjacent incidence plane is in a range between 120 degrees and 155 degrees inclusive.

5. The optical waveguide according to claim 3, wherein an angle defined by each of the inclined faces and the adjacent incidence plane is in a range between 130 degrees and 145 degrees inclusive.

6. The optical waveguide according to claim 1, wherein the diffusing portions are inclined faces that define triangle pole shaped projections, and wherein, in relation to the incidence planes, the projections project away from the light emitting portion.

7. The optical waveguide according to claim 6, wherein an angle defined by each of the inclined faces and the adjacent incidence plane is in a range between 120 degrees and 155 degrees inclusive.

8. The optical waveguide according to claim 6, wherein an angle defined by each of the inclined faces and the adjacent incidence plane is in a range between 130 degrees and 145 degrees inclusive.

9. The optical waveguide according to claim 1, wherein the reflecting portion includes a pair of flat reflection planes, wherein each of the reflection planes extends aslant from the incidence portion toward the light emitting portion, and wherein an angle defined by each reflection plane and a plane parallel to the incidence planes is in a range between 35 degrees and 65 degrees inclusive.

10. The optical waveguide according to claim 1, wherein the reflecting portion includes a pair of flat reflection planes, wherein each of the reflection planes extends aslant from the incidence portion toward the light emitting portion, and wherein an angle defined by each reflection plane and a plane parallel to the incidence planes is in a range between 40 degrees and 50 degrees inclusive.

11. The optical waveguide according to claim 1, wherein the proportion of the incidence planes in the incidence portion is in a range between 35% and 55% inclusive.

12. The optical waveguide according to claim 1, wherein the ratio of an average value of an interval between each adjacent pair of the incidence planes to an average value of an interval between the centers of each adjacent pair of the diffusing portions is in a range between 0.25 and 0.8 inclusive.

13. The optical waveguide according to claim 1, wherein the ratio of an average value of an interval between each adjacent pair of the incidence planes to an average value of an interval between the centers of each adjacent pair of the diffusing portions is in a range between 0.45 and 0.65 inclusive.

14. The optical waveguide according to claim 1, wherein the light admitting portion is one of a plurality of light admitting portions arranged along the width direction of the light admitting portions.

15. The optical waveguide according to claim 1, wherein the point light source is one of a plurality of light sources arranged along the width direction of the light admitting portion.

16. An area light source device, comprising:
a point light source; and
an optical waveguide, which admits light from the point light source, converts the admitted light into an area light, and emits the area light,
wherein the optical waveguide includes:
a light admitting portion for admitting light from the point light source; and
a light emitting portion continuously formed with the light admitting portion, wherein the light emitting portion includes an exit plane through which admitted light is emitted, and a reflecting portion formed at a side opposite from the exit plane,
wherein the light admitting portion includes an incidence portion, which is located at a side opposite from the light emitting portion and faces the point light source, wherein the light admitting portion has a width that increases from the incidence portion toward the light emitting portion, wherein the incidence portion includes a plurality of incidence planes parallel to a width direction of the light admitting portion, and a plurality of diffusing portions for diffusing light from the point light source, wherein the incidence planes and the diffusing portions are alternately arranged along the width direction of the light admitting portion, and wherein the light admitting portion includes a reflecting portion for reflecting light diffused by the diffusing portions so that the reflected light advances toward the light emitting portion.

17. A liquid crystal display device, comprising:
a liquid crystal panel; and
an area light source device provided at a back surface of the liquid crystal panel, which is opposite from a display surface of the liquid crystal panel,
wherein the area light source device includes:
a point light source; and
an optical waveguide, which admits light from the point light source, converts the admitted light into an area light, and emits the area light,
wherein the optical waveguide includes:
a light admitting portion for admitting light from the point light source; and
a light emitting portion continuously formed with the light admitting portion, wherein the light emitting portion includes an exit plane through which admitted light is emitted, and a reflecting portion formed at a side opposite from the exit plane,
wherein the light admitting portion includes an incidence portion, which is located at a side opposite from the light emitting portion and faces the point light source, wherein the light admitting portion has a width that increases from the incidence portion toward the light emitting portion, wherein the incidence portion includes a plurality of incidence planes parallel to a width direction of the light admitting portion, and a plurality of diffusing portions for diffusing light from the point light source, wherein the incidence planes and the diffusing portions are alternately arranged along the width direction of the light admitting portion, and wherein the light admitting portion includes a reflecting portion for reflecting light diffused by the diffusing portions so that the reflected light advances toward the light emitting portion.
